(19) United States
(12) Patent Application Publication
(10) Pub. No.: US 2026/0210590 A1
(43) Pub. Date: Jul. 23, 2026

(54) A SHAPE MEMORY ALLOY HEAT PUMP

(71) Applicant: EXERGYN LTD., Dublin (IE)

(72) Inventor: Greg PITTAM, Dublin (IE)

(21) Appl. No.: 19/140,775

(22) PCT Filed: Dec. 22, 2023
(86) PCT No.: PCT/EP2023/087670

§ 371 Date: Jun. 18, 2025

(30) Foreign Application Priority Data
Dec. 23, 2022 (GB) 2219728.9

(51) Int. Cl. F25B 23/00; F03G 7/06; F25B 49/00

(52) U.S. Cl. CPC F25B 23/00; F03G 7/0641; F25B 49/00

(57) ABSTRACT

The present invention relates to a Shape-Memory Alloy heat pump system comprising at least three Shape-Memory Alloy (SMA) cores; a loading and unloading mechanism to convert the SMA cores from one crystalline state to another crystalline state, such that each core can release heat when loading and absorb heat when unloading; a fluid delivery system comprising one or more fluid lines of specific volumes to deliver fluid to the SMA cores; a set of controllable orifices positioned between each SMA core to enable a number of fluid delivery paths to deliver fluid; a controller implemented with specific parameters and logic to control the loading and unloading of the SMA cores, the flow rate of fluid through the fluid delivery system and the opening and closing of the orifices such that an optimal cycle is achieved to maximise heat recovery.

### FIELD

The present disclosure relates to a Shape Memory Alloy (SMA) heat pump. In particular the disclosure relates to recovering heat in a heat pump cycle to boost efficiency in a solid state SMA heat pump.

### BACKGROUND

Recent research into the Elastocaloric [EC] effect has demonstrated its potential as a solid-state alternative to traditional Vapour Compression cooling, refrigeration and/or heat pumping approaches. The EC cycle takes advantage of the superelastic behaviour of Shape Memory Alloy (SMA), which facilitates, through cyclic uniaxial loading and unloading, the absorption of heat from a low temperature source and its rejection to a higher temperature sink.

There has been a lot of interest recently in the use of SMA material to make energy recovery devices and heat pump/refrigeration systems. One example of a use of SMA plate material is in a heat pump device comprising at least one stack of a plurality of plates where at least two plates are formed of a SMA material and assembled, the plurality of SMA plates having one or a plurality of fluid ports adapted to allow passage of a working fluid through the stack. Such an application of a SMA stack application is disclosed in PCT patent publication number WO2021/219667, assigned to Exergyn Ltd.

Heat Pump (“HP”) technologies have gained wide commercial acceptance in Heating, Ventilation, Air Conditioning and Refrigeration (“HVAC-R”) applications. They can offer energy savings and emission reductions and are typically installed for heating and cooling systems in buildings, cars, etc.

Heat pumps using SMA tubes are known in the art. SMA refers to alloys that preserve a shape deformed by an external force below a critical temperature, whereas a shape memory effect of the alloy is activated for recovering a memorized original shape by a shape recovering force after being heated to the critical temperature. SMAs such as titanium-nickel alloy are fabricated at a high temperature to have a predetermined shape.

An example of an SMA heating cooling system is described in U.S. Pat. No. 10,823,465, Radermacher et al, which discloses a heating and cooling system using a plurality of elastocaloric or thermoelastic modules arranged in pairs. A thermal wave is used to describe how fluid at different temperatures moves through a system that is controlled by a pump positioned in situ. A thermal wave is a term to describe the fluid travelling through the system to define the thermal profile of the fluid at different times during operation. A problem with this system is that the mixing of fluids is a challenge which makes operation inefficient. This also has an effect that heat recovery in the thermoelastic modules between cycles is inefficient.

Due to the cyclic nature of changing states in an SMA based heat pump system it is desirable to make the system as energy efficient as possible. In a heat pump system embodiment one or more SMA cores can be connected together. FIG. 1 shows a prior art heat pump system where fluid streams are inputted into an SMA core at hot and cold temperatures where a mechanical force actuates the core between cycles. For example, in operation the internal fluid temperatures at the heat exchanger can be 35.25° C. on the hot side and 6.8° C. on the cold. Thus for the heat pump to work the SMA needs to be above 35.25° C. to reject heat into the hot stream and be below 6.8° C. to absorb heat from the cold stream. In this example, SMA temperature has to change by nearly 30° C. between the heat absorption and heat rejection phases of operation. Due to the thermal mass of the SMA it takes a lot of energy to achieve this temperature change.

There is therefore a need for an SMA heat pump which maximises heat recovery from available heat between heat rejection and heat absorption, and this forms an objective of the present invention.

### SUMMARY

The present invention relates to a heat pump system and method of controlling a heat pump, as set out in the appended claims.

In one embodiment of the invention there is provided a heat pump system comprising:
at least three Shape-Memory Alloy (SMA) cores;
a loading and unloading mechanism to convert the SMA cores from one crystalline state to another crystalline state, such that each core can release heat when loading and absorb heat when unloading;
a fluid delivery system comprising one or more fluid lines of specific volumes to deliver fluid to the SMA cores;
a set of controllable orifices positioned between each SMA core to enable a number of fluid delivery paths to deliver fluid; and
a controller implemented with specific parameters and logic to control the loading and unloading of the SMA cores, the flow rate of fluid through the fluid delivery system and the opening and closing of the orifices during operation, such that an optimal cycle is achieved to maximise heat recovery.

In one embodiment a fluid pump is positioned in one of the fluid lines going to or from a heat sink and/or a heat source, such that the pump resides in a part of the circuit where the fluid is at a near constant temperature. By moving the pump away from a part of the circuit that sees a temperature gradient, the thermal wave that travels around the system for heat recovery is not disrupted. The thermal mass of the pump does not interfere with the heat recovery.

In one embodiment at least three Shape-Memory Alloy (SMA) cores operate out of phase with respect to each other. The operation of the SMA cores are set out of phase by using the formula N/360 Degrees, wherein N is the number of SMA cores in the system.

In one embodiment the set of controllable orifices are positioned at a point between each SMA core which enables three different fluid flow paths.

In one embodiment the three different fluid flow paths comprise:
a flow path from the previous SMA core to a heat source and from a heat source to the next SMA core;
a flow path from the previous SMA core to the heat sink and from the heat sink to the next SMA core;
a flow path from the previous SMA core directly to the next SMA core.

In one embodiment the fluid flow path comprises a pipe, and the geometry and volume of the total pipe length between a SMA core and the next SMA core, when connected together, is of a specific tuned value, such that heat recovery using a thermal wave in the fluid is optimised.

In one embodiment a variable speed fluid pump controls the flow rate of the fluid variably to allow optimal operation at a variety of cycle times.

In one embodiment a check valve is positioned in the fluid line between two SMA cores and after a controllable orifice, to ensure that fluid does not flow in the wrong direction during the opening and closing of the orifices, thereby minimising mixing.

In one embodiment the heat pump system as claimed in any preceding claim wherein the fluid delivery system comprises a valve assembly positioned between two SMA cores and configured with the at least three SMA Cores to perform the following steps:
a. Deliver heated fluid to a heat source from a previous SMA core and deliver fluid to a next SMA core from a heat source.
b. Deliver cooled fluid to a heat sink from a previous SMA core and deliver fluid to a next SMA core from heat sink.
c. Providing fluid to a next SMA core from a previous SMA core.

In one embodiment the fluid volume between an SMA core and the next SMA core can be switched between two distinct volumes, wherein one volume is optimised for running at peak power and the other optimised for running at peak COP.

In one embodiment the fluid volume between an SMA core and the next SMA core is variable between a minimum and maximum, such that the fluid volume can be optimised for any operating point between and including the peak power and peak COP operating points.

In another embodiment there is provided a Shape-Memory Alloy heat pump system comprising:
at least three Shape-Memory Alloy (SMA) cores;
a loading and unloading mechanism to convert the SMA cores from one crystalline state to another crystalline state, such that each core can release heat when loading and absorb heat when unloading;
a fluid delivery system comprising one or more fluid lines of specific volumes to deliver fluid to the SMA cores;
a set of controllable orifices positioned between each SMA core to enable a number of fluid delivery paths to deliver fluid; and
a fluid pump positioned in one of the fluid lines going to or from a heat sink and/or a heat source, such that the pump resides in fluid at a near constant temperature.

In a further embodiment there is provided a method of controlling a Shape-Memory Alloy heat pump system comprising:
positioning at least three Shape-Memory Alloy (SMA) cores in communication with each other;
loading and unloading the SMA cores to convert from one crystalline state to another crystalline state, such that each core can release heat when loading and absorb heat when unloading;
delivering fluid one or more fluid lines of specific volumes to deliver fluid to the SMA cores;
positioning a set of controllable orifices between each SMA core to enable a number of fluid delivery paths to deliver fluid; and
controlling the loading and unloading of the SMA cores, the flow rate of fluid through the fluid delivery system and the opening and closing of the orifices during operation.

### BRIEF DESCRIPTION OF THE DRAWINGS

The invention will be more clearly understood from the following description of an embodiment thereof, given by way of example only, with reference to the accompanying drawings, in which:—

FIG. 1 is a high level system diagram of a Heat Pump system;

FIG. 2 is a graph showing how heat recovery is achieved by using the temperature gradient of the fluid coming out of a core as the temperature gradient into the same core at a later point;

FIG. 3a illustrates a heat pump system comprising a single SMA core, according to a first aspect of the present invention;

FIG. 3b illustrates a heat pump system comprising two SMA cores, according to a first aspect of the present invention;

FIG. 4a illustrates a heat pump system comprising a single SMA core according to a second aspect of the invention;

FIG. 4b illustrates a heat pump system comprising two SMA cores, according to a second aspect of the invention;

FIG. 5a-c illustrate a heat pump system comprising three to five SMA cores, according to a third aspect of the present invention;

FIG. 5d illustrates a heat pump system comprising four SMA cores split over two stacks per core and run as a two stage cascade according to the third aspect of the present invention;

FIGS. 6 and 7 show that the performance of the heat pump can be varied by altering the volume of fluid in the pipework between the cores in the heat pump system shown in FIG. 5;

FIG. 8a illustrates a heat pump system comprising four SMA cores, according to a fourth aspect of the present invention; and

FIGS. 8b to 8e illustrate a number embodiments of a heat pump system according to a fourth aspect of the present invention.

### DETAILED DESCRIPTION OF THE DRAWINGS

The operation of a heat pump using SMA material is known and fully described in PCT patent publication number WO2019/149783, assigned to the assignee of the present invention, and incorporated fully herein by reference. The present invention is particularly concerned with a heat pump system having one or more SMA cores in a system. The, or each, core can be made up of one or more plates of SMA material positioned in a stack arrangement to define a single SMA core. The SMA core may also be made up of sheets and/or ribbons of SMA material or any form. In the context of the present invention any caloric material can be used to implement a heat pump system.

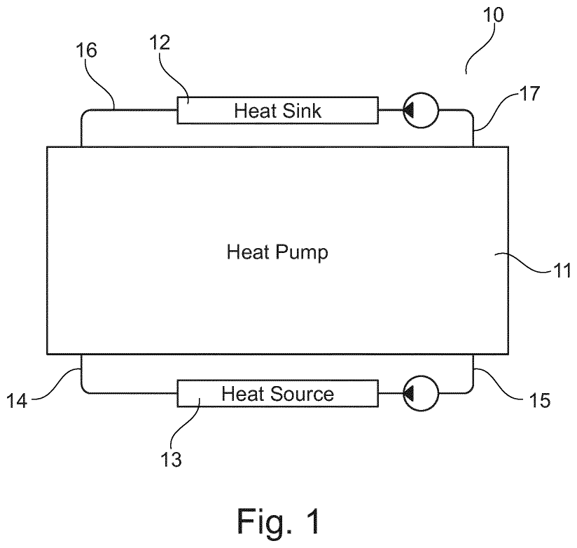

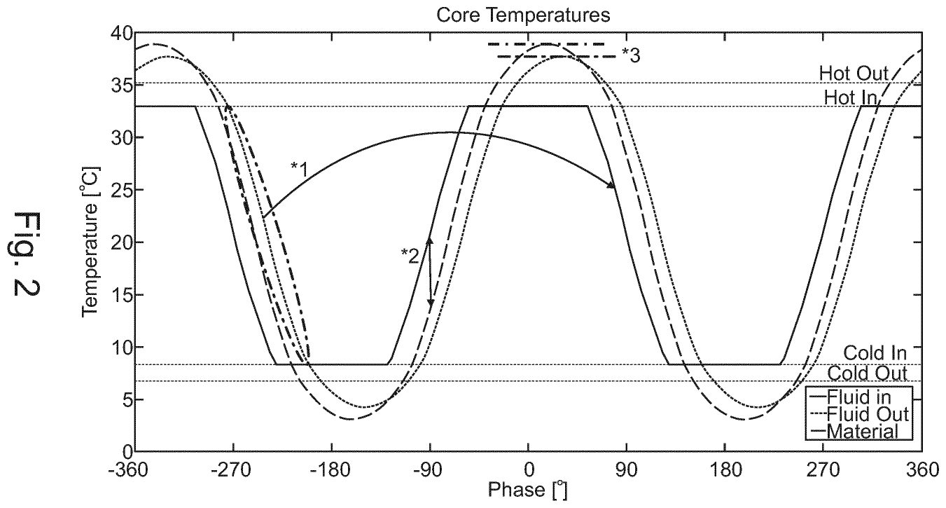

FIG. 1 is a high level system diagram of a SMA material based Heat Pump system indicated generally by the reference numeral 10. A housing 11 houses one or more SMA cores that are in fluid communication with a heat sink and heat source 12, 13. The heat pump is configured to pump heat from the heat source (usually colder) to the heat sink (usually warmer). An air conditioning/refrigeration uses the reverse. One or more fluid streams are inputted into an SMA core at hot and cold temperatures and a variable stress can be applied to the SMA core. For example, in operation the internal fluid temperatures at the heat sink 12 can be 36° C. and 6° C. at the heat source 13. Thus for the heat pump 10 to work the SMA material needs to be above 36° C. to reject heat into the hot stream and be below 6° C. to absorb heat from the cold stream.

Heat, either stored from when the SMA core was previously hot or from a second core that is currently hot can be used to increase the temperature of a cold core closer to the temperature required for heat rejection. In the simplistic case, if a cold core and a hot core are connected together thermally, then they would both find equilibrium at the mid temperature, reducing the thermal losses in half.

However, by replicating the behaviour of a counter flow heat exchanger it is possible (given infinite time and thermal conductivity) to fully heat a cold core up to the temperature required and simultaneously fully cool a hot core down to the temperature required.

FIG. 2 is a graph showing how heat recovery can be achieved by using the temperature gradient of the fluid out of a core as a temperature gradient into the core at a later point. This is illustrated as *1 in FIG. 2. FIG. 2 illustrates an ideal temperature profile for fluid into and out of a core along with the actual core temperature. The phase shift between fluid out and fluid in is due to the length of the core. When the temperature of fluid out of the core is greater than the ‘hot in’ 16 temperature, then that fluid is directed to the ‘hot out’ 17 stream running into the heat sink 12. The same is true when the temperature of fluid out of the core is lower than the ‘cold in’ 14 temperature; the fluid is directed to the ‘cold out’ 15 stream running into the heat source 13. When the fluid out is between these two temperatures, then a heat recovery system is required to store this temperature gradient and use it later in the cycle, or in another core, as the fluid into the core (*1). For optimal performance the temperature delta between the fluid in and the material should be minimised (*2). In addition, the temperature delta between the material and fluid out should be minimised (*3) on both the hot and cold sides.

According to a first aspect of the invention there is provided a heat recovery system to achieve point *1 in FIG. 2. The invention achieves this by storing and later using the temperature gradient in the fluid coming out of an SMA core.

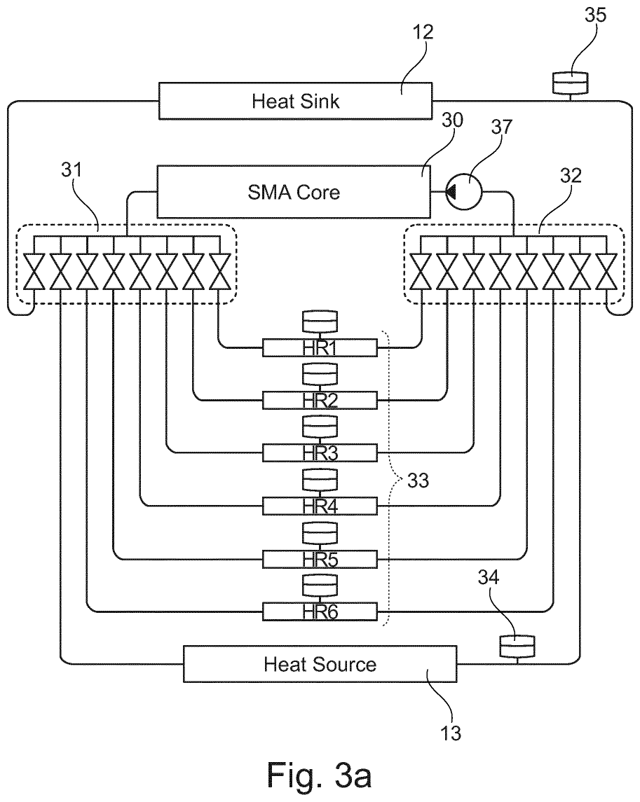

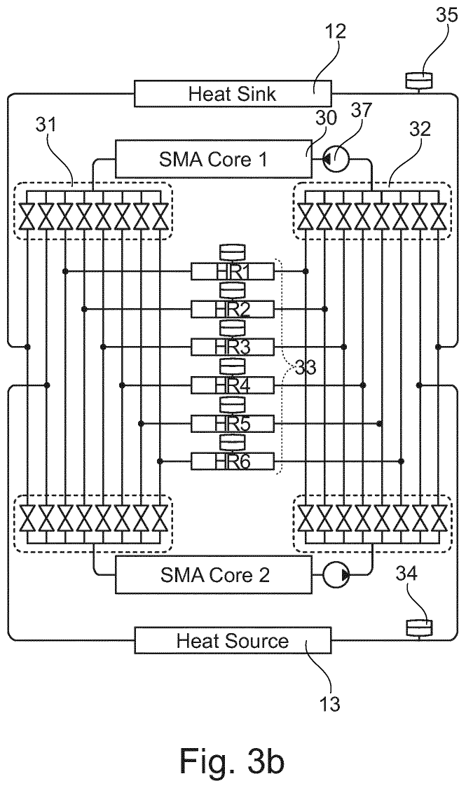

FIG. 3a illustrates a heat pump system comprising a single SMA core indicated by the reference numeral 30. Fluid can enter one side at an inlet of the core 30 and exit at an outlet side. As the fluid comes out of the core the fluid is split into a number of streams by a valve assembly 31. The temperature of each stream is different to the others and each is relatively constant. Another valve assembly 32 is positioned in fluid communication with the inlet to the core 30. The fluid in the streams is then put into the core one stream after the other for heat recovery, which is controlled by the valve assembly 31, 32. The larger the number of streams, the better the heat recovery performance.

As illustrated in FIG. 3a the SMA core 30 requires a pump 37 and two sets of 1:ns way valves to direct the fluid, shown as valve assembles 31, 32, where ‘ns’ is the number of heat recovery streams plus the heat sink and heat source streams. Six heat recovery streams are shown with the result that there needs to be a 1:8 way valve at the inlet and outlet of the SMA core 30. Any number of heat recovery streams can be used. The timing is completely flexible enabling high performance. Each stream needs a fluid storage volume 33 (HR1-HR6) as there are times when fluid is being pumped into a stream without fluid being taken out, and other times when fluid is being taken out without any fluid being provided. A fluid storage volume 34, 35 is also required on the heat sink and heat source lines. The pump 37 needs to have low thermal mass and conductivity, and not mix the fluid from different fluid streams. It will be appreciated that with a single core you are never taking fluid from the same line as you are putting it into, so each stream is only ever in 1 of 3 states. Idle: being filled, being emptied.

FIG. 3b illustrates a heat pump system comprising two SMA cores, according to a first aspect of the present invention, this time with two cores. The second core also requires its own fluid pump and set of valves on the inlet and outlet. The heat recovery streams (HR1-HR6) and the heat sink and source are shared with the first core. Suitably, although not essential, core 2 can be run 180° out of phase with core 1, such that the fluid storage volume is reduced and the flow rate any part of the circuit is kept more constant. Any number of cores could be added in this way, with each core requiring its own set of valves and pump. Ideally each core would be run out of phase by 360/nCores where nCores is the number of cores in the system.

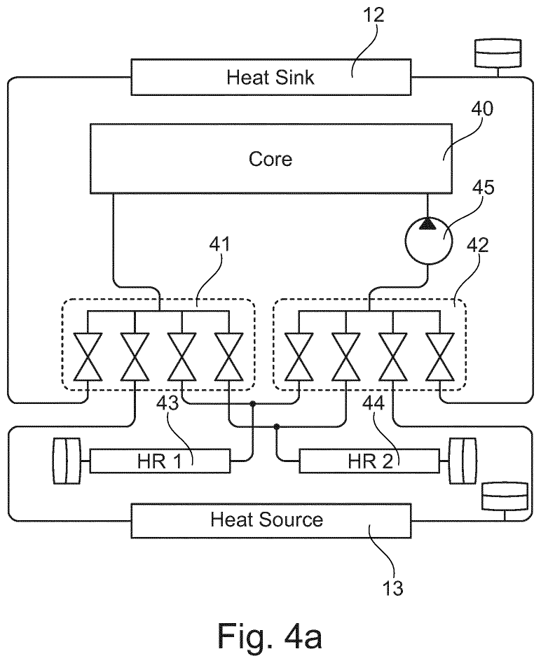

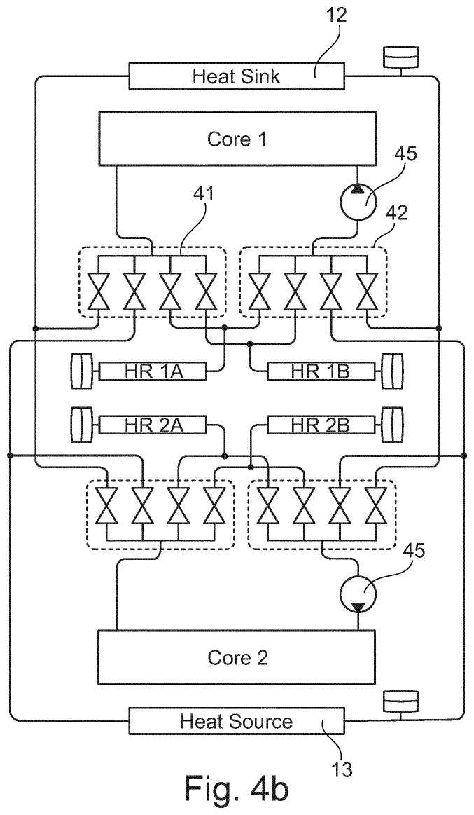

FIG. 4a illustrates a heat pump system comprising a single SMA core indicated by the reference numeral 40 which makes use of temperature gradient streams of fluid to heat or cool the core. Fluid can enter one side at an inlet of the core 40 and exit at an outlet side. As the fluid comes out of the core 40 the fluid is split into a number of streams by a valve assembly 41. In this instance there are four streams; heat sink, heat source, HR1 and HR2. Another valve assembly 42 is positioned in fluid communication with the inlet to the core 40. The fluid that comes out of the core 40 is stored with a temperature gradient across two heat recovery volumes 43, 44. These fluid volumes are then used later in the cycle for heat recovery. The better the temperature gradient can be maintained within the heat recovery volumes, the better the performance.

The sets of valves 42 and 41 are only 1:4 way valves, so reduced in complexity compared to FIG. 3a. The timing is kept completely flexible to improve performance. A fluid storage volume 43, 44 is required in each heat recovery stream, such that the stream can be ‘filled’ and ‘emptied’ for each cycle. The pump 45 is required in a circuit with a temperature gradient. Thus the pump 45 should have low thermal mass & conductivity, and not mix the fluid.

Due to the requirement of a fluid storage volume within the heat recovery volumes 43, 44, it is preferable to have the fluid entering and exiting the volume at one end of the pipe and the fluid store at the other. This ensures that the fluid store is at a constant temperature, and limited mixing occurs. In doing so, this means that if a stream of fluid was put into the store with a temperature gradient that started at 10° C. and increased to 30° C., then when it is taken out later in the cycle it will appear reversed with first the 30° C. fluid leaving the store with it then decreasing to 10° C. once fully removed from the store. This ‘flipping’ of the fluid temperature gradient means that the fluid stored when the core was cooling down is then used to warm the core up. Thus a second storage volume is included which stores the fluid when the core is heating up and is then used to cool the core down.

It will be appreciated that this system can work with a number of cores, with each core having its own pair of heat recovery streams, valve assemblies and pump. FIG. 4b illustrates a heat pump system comprising two SMA cores where each core has it's own pump, valve assembly and heat recovery volumes. The two cores share the same heat sink and source. As more cores are added, ideally each core can be run out of phase by 360/nCores where nCores is the number of cores in the system.

By adding more cores to the system, the flow through the heat source and sink is more consistent, increasing the overall system performance. It was found that 100% heat sink/source utilization is achieved with three or more cores. Ideally the heat pump system will have three cores, with each core having its own heat recovery system as shown in FIGS. 4a and 4b.

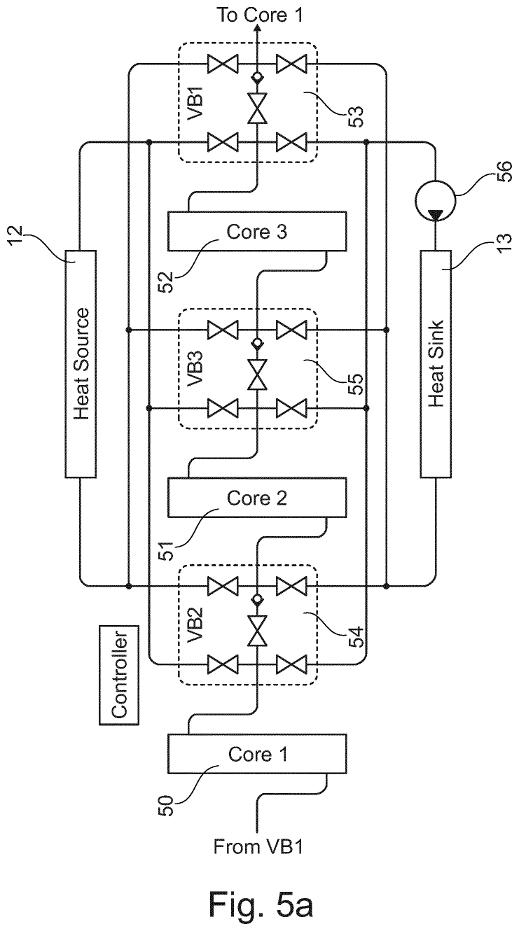

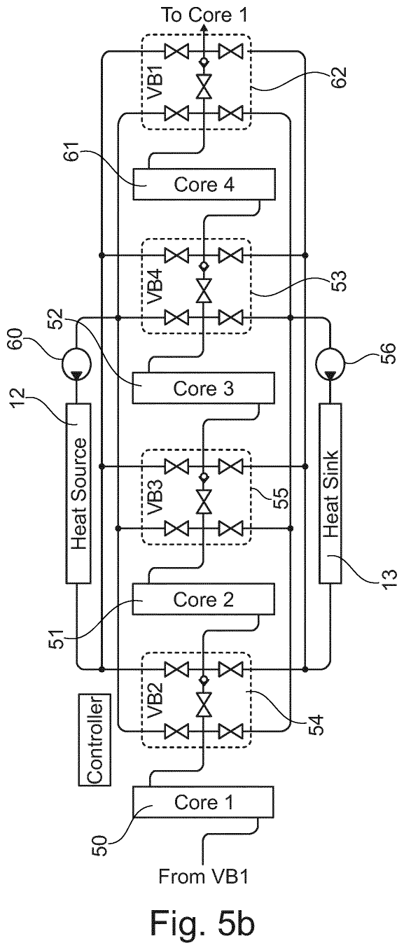

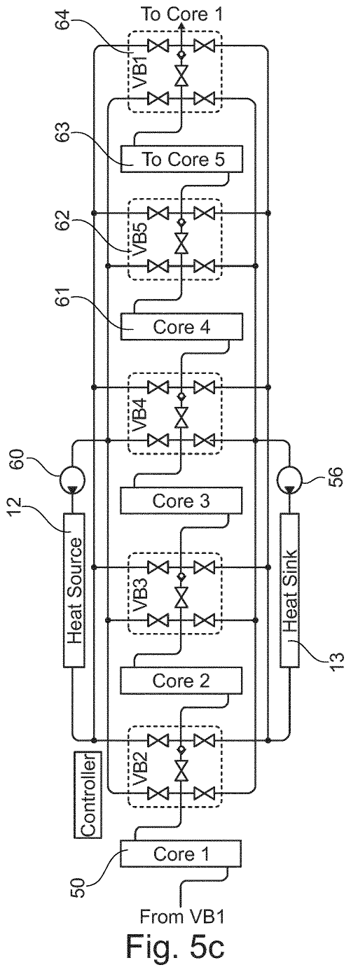

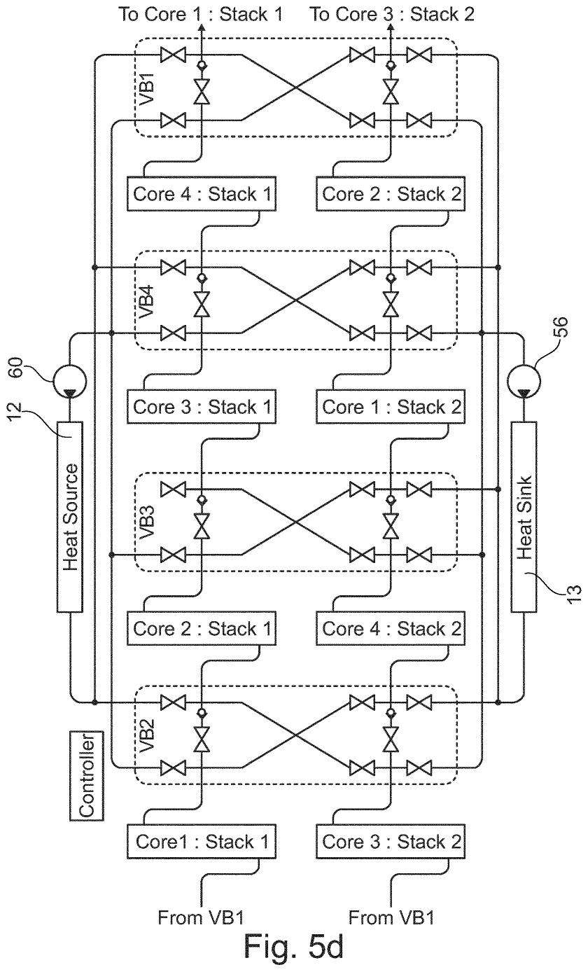

FIGS. 5a, 5b and 5c show three embodiments of a third heat pump embodiment utilising three, four and five cores respectively. The heat pump uses a thermal wave heat recovery concept and can work with three or more cores. Differing numbers of cores produce variation in the relative time spent doing heat rejection/absorption and heat recovery. Table 1 below shows a number of examples for the amount of time spent doing heat rejection/absorption and heat recovery for a given number of cores, such that each cycle is made up of 360°.

For applications requiring a large delta-T it may be suitable to use more cores where more time is spent doing heat recovery. For applications with low delta-T it may be suitable to choose a small number of cores where less time is spent doing heat recovery.

In operation exactly one core will be doing heat rejection and recovery, the remaining cores will be doing heat recovery. For five or more cores, it is possible to have exactly two cores doing heat rejection and heat absorption whilst the remaining cores are doing heat recovery.

TABLE 1
Number of cores vs cycle time split

| Number | Heat Rejection and Heat | Heat Recovery |
|---|---|---|
| of Cores | Absorption Phases | Phases |
| 3 | 120° | 60° |
| 4 | 90° | 90° |
| 5 | 72°/144° | 108°/36° |
| 6 | 60°/120° | 120°/60° |
| 7 | 51.4°/102.9° | 128.6°/77.1° |

FIG. 5a illustrates a heat pump system comprising three SMA cores indicated by the reference numerals 50, 51, 52 which makes use of thermal wave heat recovery. Between each core is a set of controllable orifices VB1 53, VB2 54, VB3 55 which direct the fluid in one of three ways:
1. To and from the heat source
2. To and from the heat sink
3. From one core to the next.

The VB's can be placed anywhere along the pipe from one core to the next. However, there is a performance advantage to having the VB's close to the core where the fluid is coming from and having most of the length in the pipe going to the next core. In the diagram they are drawn in the middle between the two cores. In addition, although all five controllable orifices are drawn in a group, the controllable orifices from and to the heat sink/source can be positioned anywhere on that line. A controller is provided to control the set of controllable orifices VB1 53, VB2 54, VB3 55. The controller is programmed with specific parameters and logic software to control the loading and unloading of the SMA cores, the flow rate of fluid through the fluid delivery system and the opening and closing of the orifices during operation, such that an optimal cycle is achieved to maximise heat recovery.

An optional non-return valve can be fitted after each of the controllable orifices connecting the two cores together. This stops fluid running back the wrong way around the circuit during the short period that the valves are opening and closing. With very fast acting valves, the check valve can be omitted.

The volume and geometry of the pipe which connects the two cores together is of importance such that an optimal cycle is achieved to maximise heat recovery. It must be sized such that the thermal wave propagates along the pipe length and to the next core in the time available. It is possible to tune this for a given pipe volume by adjusting the flow rate and cycle time. Adjusting the flow rate and cycle time can be controlled by the controller. For example, if the flow rate is doubled, then the cycle time has to be halved for a given fixed pipe volume.

The pump 56 is situated on the line going to the heat sink in FIG. 5a, however it could also be placed on the line from the heat sink or to/from the heat source. In addition a second pump could be installed at the heat source to reduce the head seen by the pump. Doing so on a three core system results in the pump head changing throughout the cycle, however on a four core system that would not be an issue. This provides a performance improvement over competing designs as the pump does not reside in a part of the fluid that contains a temperature gradient. Pumps in the temperature gradient disrupt the gradient due to their thermal mass and fluid mixing. By placing the pump on the heat sink/source pipe line, the thermal mass and fluid mixing is of no consequence.

FIGS. 5b and 5c show the four core and five core embodiments of the same concept. The arrangement is the same, with additional cores 61, 63 and VB's 62, 64 connected. The only change is the change to the control software which will control the valves at different times depending on the number of cores in the system, to maintain the timings shown in Table 1. The four-core embodiment has the potential advantage that an optional second pump 60 on the heat source line can be included without having issues of varying head throughout the cycle.

It will be appreciated the embodiments shown in FIGS. 5a, 5b and 5c have a number of advantages over the other presented circuits. Only five valves per core are required for efficient heat recovery operation. Compared with the embodiments of FIGS. 3 and 4 no fluid volume stores are needed as all pipes are always flowing at the same rate. A 100% heat source/sink utilisation minimises the temperature delta across each core. In addition, the pumps can be situated on lines with constant temperature, meaning the pumps can have high thermal mass/conductivity without issues relating to the mixing of fluids.

In an alternative embodiment, a two-volume fluid system for an improved or wider performance envelope of a solid-state heat pump using heat recovery can be implemented using a variable volume of fluid between cores. In FIGS. 5a, 5b and 5c the pipes connecting the cores are of a fixed length to deliver a fixed volume of fluid between cores.

FIG. 5d shows an embodiment of the third concept utilising four cores but run as a two stage cascade. Such a system is required to gain higher delta-T's than is possible in a single stage. Such a system would usually have different SMA material in stacks 1 and 2, with each material tuned to a different temperature range. In FIG. 5d a similar arrangement to that in FIG. 5b is shown, except two valve systems VB1, VB2, VB3 and VB4, are connected together. The purpose of connecting them together is so that the heated fluid out of the colder stage is used as the cold inlet to the hotter stage. In the opposite direction the cooled outlet from the hotter stage is used as the hot inlet of the colder stage. By connecting the two systems together in this way, all of the heat recovery benefits of FIGS. 5a, 5b and 5c are retained, but with the increased delta-T achieved with a two-stage cascade. In this example, two of the valves from each set can be removed due to duplication, so the total number of valves is less than double that required on a single stage. The method used to connect two systems together to produce a cascade could be used with any of the concepts shown. It is simply a case of connecting the ‘hot’ out of the cold stage to the ‘cold in’ of the hotter stage and the ‘hot out’ of the colder stage with the ‘cold in’ of the hotter stage.

With a fixed volume of fluid between the cores in systems FIGS. 5a-5d, the performance of the device is varied by adjusting the cycle time. Due to the fixed fluid volume, the flow rate is adjusted inversely proportional to the cycle time, such that optimal phasing of the thermal wave around the circuit is maintained. However, the fixed fluid volume will only be optimal at one cycle time. Going to longer cycle times, will then result in the need for lower flow rates than would be optimal. Going to shorter cycle times would result in higher flow rates than would be optimal. A solution to this would be to implement a system whose fluid volume between cores could be adjusted depending on the current operating point.

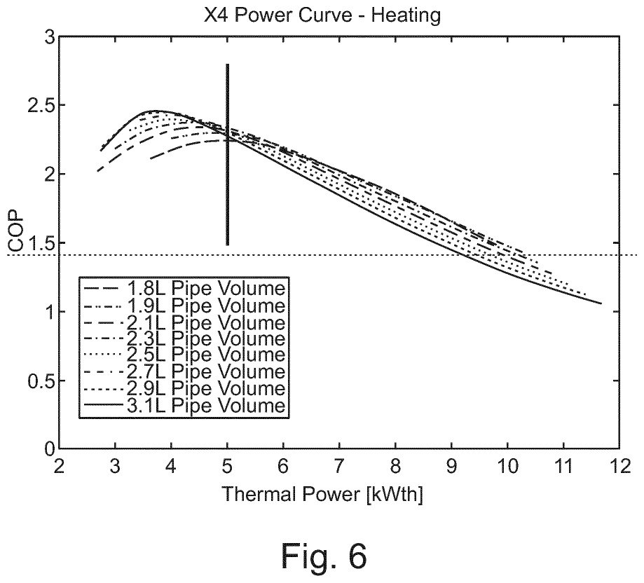

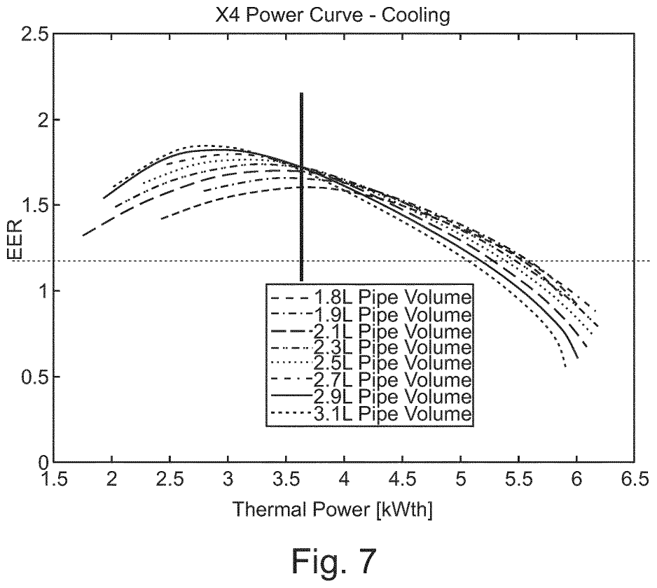

FIGS. 6 and 7 show from modelling that different volumes give higher CoP depending on the thermal output power. The graphs in FIGS. 6 and 7 show the CoP vs kWth and EER (Energy Efficiency Ratio) vs kWth for heating and cooling respectively in a four SMA core heat pump embodiment. An ideal system would allow the volume to vary continuously, such that the system could always be at the peak COP/EER for the required heating/cooling power. However, most of the performance increase could be obtained by using just two discrete volumes. In the example in FIG. 6, when running at heating power below 5 kWth (perpendicular dark line), one would use a 3 L fluid volume. When operating at higher thermal power output, one would use a 2 L volume. A system without the flexibility to change fluid volume would need to choose a volume in between at say 2.5 L, however there would be a reduced COP at most operating points.

For cooling, as shown in FIG. 7, a fluid volume of 3 litres when below 3.7 kWth is best, but when above 3.7 kWth a 2 litre volume is found to be optimum.

Two discrete volumes could be provided by a simple 3-way valve with extra pipework on each line between the cores. With the valve in one position, the fluid path would be 2 L and with the valve in the other position, extra pipework would then be connected, making the fluid volume 3 L.

A continuously variable pipe section could be created using a telescopic pipe section on each pipeline between the cores. By extending the telescopic pieces, the volume will increase. Retracting the telescopic pipework would then reduce the volume again.

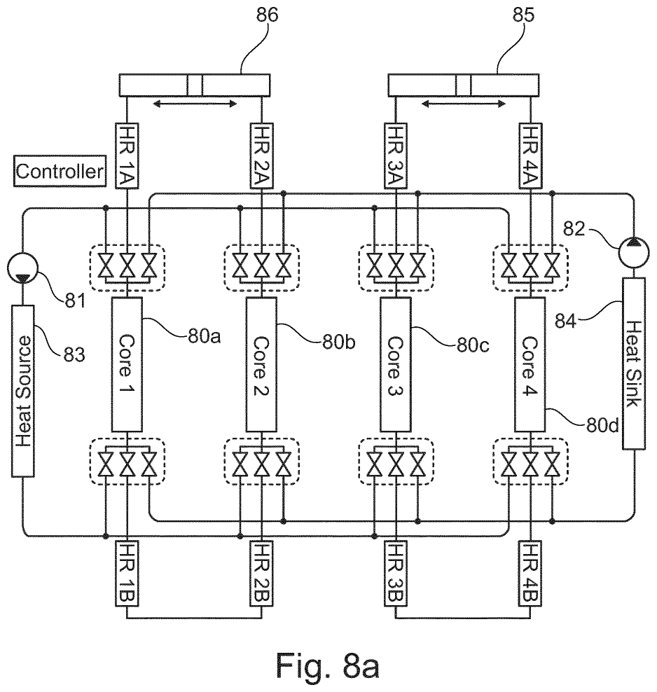

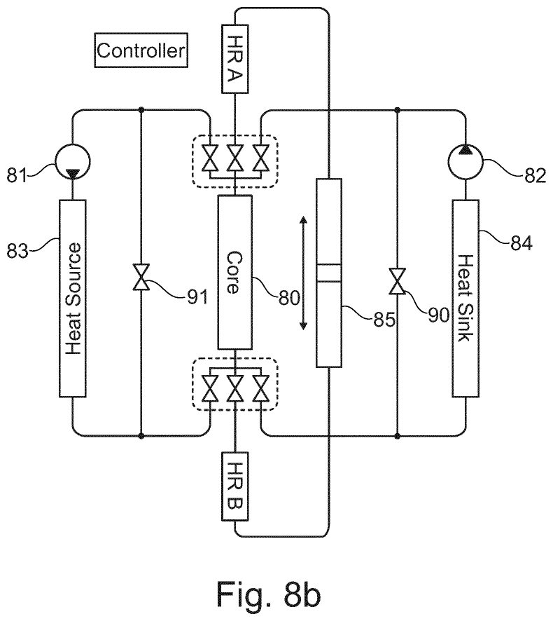

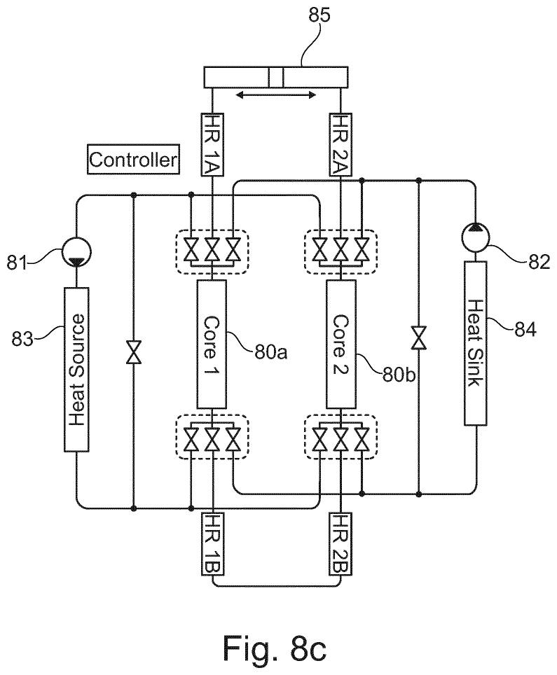

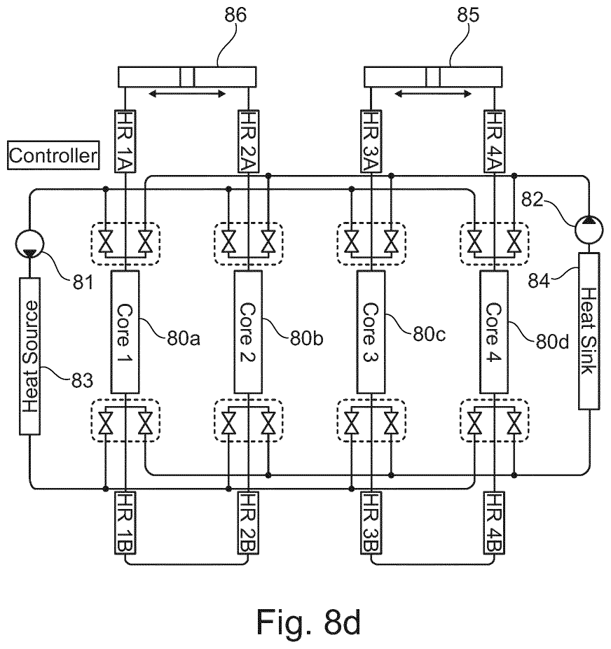

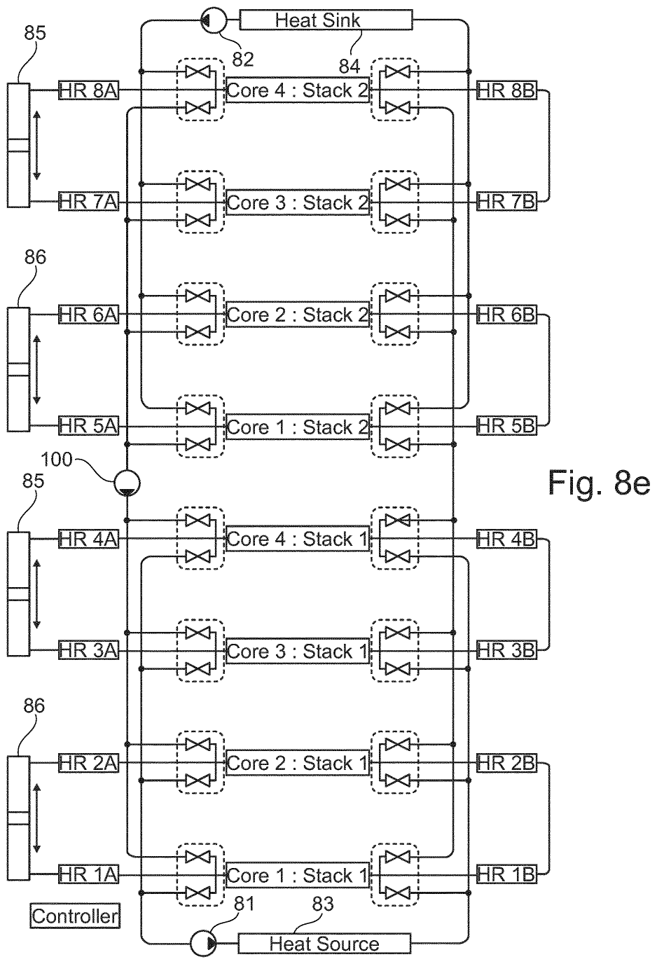

FIG. 8a illustrates a heat pump system comprising four SMA cores 80a, 80b, 80c, 80d, according to a fourth aspect of the present invention. In this embodiment the fluid passes through the SMA cores in different directions at different points in the cycle. Alternating the flow direction of the fluid allows for greater SMA efficiency. The benefit to this is that one end of a core is always warmer than the other, meaning that no SMA sees the full temperature range of the heat pump. The reduced temperature range seen by the SMA can result in increased SMA performance. The arrangement shown is a four-core embodiment, however the invention can be used with any number of cores. The benefit to using four cores is 100% heat exchanger utilisation and thus lower overall temperature deltas and constant pump operation. In this invention a pump 81, 82 is positioned on or near a heat source 83 and a heat sink 84. The pump 81, 82 runs continuously at constant speed. Fluid from the heat source 83 is pumped through each of the four cores in the sequence 1, 3, 2, 4. The heat rejection and heat absorption parts of the cycle are 180° apart. The remaining part of the cycle is spent doing heat recovery. During heat recovery a piston 85, 86 is used to move fluid into and out of two cores simultaneously. The piston can be replaced with a bidirectional pump. Fluid volumes HR1a to HR4b store fluid with a temperature gradient across HR1a to HR4b. During heat recovery, this temperature gradient is passed through the core and is used to change the temperature of the core from the hot temperature to the cold temperature and vice versa. The fluid out of the core during this phase is stored in the opposite HR volume, for use half a cycle later. When the heat pump is first started, these HR volumes will be at ambient temperature, it takes a number of cycles for the steady state temperature gradient to develop. An advantage of this embodiment is that a more consistent delta T is achieved across the core. This can deliver operational benefits, such as longer life cycle of the SMA material.

A perfectly tuned cycle is now described, starting with the cooling phase. In the cooling phase of the cycle, fluid from the heat source 83 is passed into a core whilst the core is unloading. The core acts to cool the fluid down. The fluid out of the core will be directed back to the heat source whilst the fluid is below the inlet temperature. Thus, providing cooling to the heat source 83. When the cooling is used up and the temperature of the fluid out of the core matches the temperature in, the valves change and the fluid is now directed into the HRa circuit. At the same time the fluid entering the core is from HRb circuit. The fluid entering is initially cold, but then slowly increases up to the hot inlet temperature. The idea being that the core is warmed by this fluid from the cold side temperature to the hot side temperature. At the same time the fluid going into HRa starts off being cold but then warms up as the core is warmed creating a temperature gradient in the HRa stream to be used later.

Once the heat recovery process is complete, the fluid from the heat sink is directed into the core. At this point the flow direction changes and the hot fluid enters the core where it was previously leaving. At this point the core is loaded causing the core to reject heat and heat the fluid within the core, the heated fluid exits the core into the heat sink, warming it. Once all of the heating has been exhausted and the core outlet temp matches the inlet, the valves are again switched such that fluid is coming into the core from HRa and back into HRb. Notice that the flow direction hasn't changed again, so the HR is flowing in the opposite direction to how it was half a cycle ago. The fluid coming from HRa starts off warm and then slowly drops to the cold inlet temperature. This cools the core down towards the cold temperature. The fluid out of the core, initially quite hot, is directed into HRb, over time the fluid temperature drops too, creating a temperature gradient in HRb, that will be used for HR in half a cycle. Once the HR process is complete, the cycle starts over again.

FIG. 8b illustrates a single core 80 embodiment according to the fourth aspect of the present invention. Included are two optional control valves 90, 91 on the heat sink 84 and heat source 83. These allow the pumps 81, 82 to circulate fluid even when the core 80 is not connected. Alternatively the valves 90, 91 can be removed and the pumps 81, 82 run intermittently. A single piston 85 or bidirectional pump is required for the heat recovery part of the circuit.

FIG. 8c illustrates a two core 80a, 80b embodiment according to the fourth aspect of the present invention. As per the single core embodiment of FIG. 8b, control valves are included on the heat sink and heat source to allow continuous operation of the pump 81, 82. The piston 85 or bidirectional pump on the heat recovery circuit is shared between two cores 80a, 80b. The two cores are run 180° out of phase with each other.

FIG. 8d illustrates a four core embodiment according to the fourth aspect of the present invention. The arrangement is identical to FIG. 8a, except that the valves on the heat recovery circuit are removed. This is an optional simplification of FIG. 8a which results in a more simple system with fewer components. It is made possible as flow in these lines is controlled by the movement of the piston or bidirectional pump. Thus unless these are operating, fluid cannot enter or leave the heat recovery circuit, making the valves shown in FIG. 8a redundant.

FIG. 8e illustrates a four core, two stage embodiment according to the fourth aspect of the present invention. Such a system is required to gain higher delta-T's than is possible in a single stage. Such a system would usually have different SMA material in stacks 1 and 2, with each material tuned to a different temperature range. In FIG. 8e a similar arrangement to that in FIG. 8d is shown, except that there are two systems connected together. The two systems are connected at the point where there would be a heat sink/source in a single stage system. A pump is needed between the two system to maintain the flow of fluid between them. The purpose of connecting them together is so that the heated fluid out of the colder stage is used as the cold inlet to the hotter stage. In the opposite direction the cooled outlet from the hotter stage is used as the hot inlet of the colder stage. By connecting the two systems together in this way, all of the heat recovery benefits of FIGS. 8a and 8d are retained, but with the increased delta-T achieved with a two-stage cascade.

It will be appreciated that an integrated core manifold and valve block can be implemented as close to the core outlet as possible to give best performance. Any volume of fluid between the core and the valve block has a negative effect on performance when the flow direction changes.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiments hereinbefore described but may be varied in both construction and detail.

1. A Shape-Memory Alloy heat pump system comprising:
at least three Shape-Memory Alloy (SMA) cores;
a loading and unloading mechanism to convert the SMA cores from one crystalline state to another crystalline state, such that each core can release heat when loading and absorb heat when unloading;
a fluid delivery system comprising one or more fluid lines of specific volumes to deliver fluid to the SMA cores;
a set of controllable orifices positioned between each SMA core to enable a number of fluid delivery paths to deliver fluid; and
a controller implemented with specific control parameters to control the loading and unloading of the SMA cores, the flow rate of fluid through the fluid delivery system and the opening and closing of the orifices during operation.

2. The heat pump system of claim 1, further comprising a fluid pump positioned in one of the fluid lines going to or from a heat sink and/or a heat source, such that the pump resides in fluid at a near constant temperature.

3. The heat pump system of claim 1, wherein the at least three SMA cores operate out of phase with respect to each other.

4. The heat pump system of claim 3, wherein operation of the SMA cores are set out of phase by using the formula N/360 Degrees, wherein N is the number of SMA cores in the system.

5. The heat pump system of claim 1, wherein the set of controllable orifices are positioned at a point between each SMA core which enables three different fluid flow paths.

6. The heat pump system of claim 5, wherein the three different fluid flow paths comprise:
a flow path from a previous SMA core to a heat source and from a heat source to a next SMA core;
a flow path from the previous SMA core to the heat sink and from the heat sink to the next SMA core;
a flow path from the previous SMA core directly to the next SMA core.

7. The heat pump system of claim 1, wherein the fluid flow path comprises a pipe, and the volume of the total pipe length between an SMA core and the next SMA core, when connected together, are of specific tuned values, such that heat recovery using a thermal wave in the fluid is optimised.

8. The heat pump system of claim 1, whereby a variable speed fluid pump controls the flow rate of the fluid variably to allow optimal operation at a variety of cycle times.

9. The heat pump system of claim 1, wherein a check valve is positioned in the fluid line between two SMA cores and after a controllable orifice, to ensure that fluid does not flow in the wrong direction during the opening and closing of the orifices, thereby minimise mixing.

10. The heat pump system of claim 1, wherein the fluid delivery system comprises a valve assembly positioned between two SMA cores and configured with the at least three SMA Cores to perform the following steps:
deliver heated fluid to a heat source from a previous SMA core and deliver fluid to a next SMA core from a heat source;
deliver cooled fluid to a heat sink from a previous SMA core and deliver fluid to a next SMA core from heat sink; and
providing fluid to a next SMA core from a previous SMA core.

11. The heat pump system of claim 1, wherein the fluid volume between an SMA core and the next SMA core can be switched between two distinct volumes, wherein one volume is optimised for running at peak power and the other optimised for running at peak COP.

12. The heat pump system of claim 1, wherein the fluid volume between an SMA core and the next SMA core is variable between a minimum and maximum, such that the fluid volume can be optimised for any operating point between and including the peak power and peak COP operating points.
